(19) United States
(12) Patent Application Publication
(10) Pub. No.: US 2008/0098300 A1
(43) Pub. Date: Apr. 24, 2008

(54) Method and system for extracting information from web pages

(75) Inventors: Josquin S. Corrales, Hayward, CA (US); Phillip Lan, Fremont, CA (US)

Correspondence Address: SUGHRUE MION, PLLC, 2100 Pennsylvania Avenue, N.W., Washington, DC, 20037, US

(73) Assignee: BRILLIANT SHOPPER, INC., Newark, CA (US)

(21) Appl. No.: 11/586,444

(22) Filed: Oct. 24, 2006

(51) Int. Cl. G06F 17/00; G06F 17/30; G06F 7/00

(52) U.S. Cl. 715/243; 715/234; 707/3; 707/1; 707/100

(57) ABSTRACT

A crawler collects webpage data and obtains a list of URL's of interest used to construct a searchable index. The HTML stream is received for each relevant URL and each HTML stream is imported onto a browser or rendering engine so as to render the page. From the browser, the run-time data structure for each page is obtained. From the run-time data structure, layout information of the webpage is obtained. The layout information can include location and size of images, text, video clips, banners, etc. Using various heuristics, selected items of interest are identified as relevant according to their associated layout information. Then, when a query is received and a match is found in the index, only the information identified as relevant is fetched and presented to the user.

### BACKGROUND

1. Field of the Invention

The subject invention relates to the field of identification and extraction of information from web pages and, more specifically, identification and extraction of information from a Hypertext Markup Language (HTML) source document.

2. Related Art

Many methods and systems are known in the art for identifying and extracting information from web pages, also referred to as scrapping.

Most known to users of the Internet are search engines, such as Google™, Yahoo™, MSN™, etc. These search engines generally use a crawler to collect data to generate an index. When a user enters a query, a search of the index returns webpage results matching a search term entered by the user. A more specialized system for gathering information for users relates to merchandise comparison searching, such as Shopzilla™, PriceGrabber, NexTag, PriceScan™, BizRate®, etc. Such engines provide product images, description and prices from different web stores according to a user's search term.

There are various operational manners for these web search systems; however, perhaps the most relevant can be described as follows. When the user enters a term, a search engine searches an index for webpages that have a match for the term. When a hit is found, the corresponding URL is fetched and an HTML data stream is obtained for that URL. As is known, the HTML data stream contains the information necessary for a browser to actually display the page. In order to extract the relevant information from the HTML data stream, a parser operates on the HTML stream.

Parsing is the process of analyzing an input sequence in order to determine its grammatical structure with respect to a given formal grammar. Parsing transforms input text into a data structure, usually a tree, which is suitable for later processing and which captures the implied hierarchy of the input. Generally, parsers operate in two stages, first identifying the meaningful tokens in the input, and then building a parse tree from those tokens. This process is repeated for all of the hits, and the relevant data from each page is presented to the user.

As to the search itself, search engines generally use web crawlers (also often referred to as spiders) to collect data and follow web links to various web pages. The webpages are indexed and information about each page is also stored. Some engines store part or all of the source page in a specialized data structure as well as information about the web pages, whereas some store every word of every page found. Then, when a user submits a query, the engine searches the index for the highest scoring matches and presents this information to the user. However, because of the large number of web pages available on the internet, and because many pages contain less relevant information, searchable indexes built in an all inclusive manner include many keys based on non-essential data. Consequently, the index size is increased, while the search efficiency is reduced and more desirable search results are competing for higher ranking. Therefore, many vertical engines limit the pages included in the index.

One way of limiting the indexing is by submission, which is utilized by specialized websites, such as shopping websites. Using submission, shopping sites limit their index by indexing only pages submitted to their engine by contracted third parties. This is most effective for shopping sites, since prices, availability, quantities in stock, etc., may vary daily for various items and the engines can focus on these sites to continuously update the information. Therefore, rather than search the entire web for items, the specialized or aggregating sites contract with merchants to enable efficient downloading of information via the TCP/IP Application Layer HTTP request/response protocol. According to such arrangement, the merchant provides the aggregating website a URL with search keyword query and option encoding instructions that the specialized website can use to communicate via the HTTP protocol. When the merchant's server receives a well formed HTTP request, it replies with an XML data stream that contains the information relating to the products offered on the merchant's website. Such an arrangement is efficient in two ways: first, it minimizes the number of sites the crawler has to access and, second, it minimizes crawler processing and reduces bandwidth requirements, since the crawler does not have to download and analyze each page from the site. Rather, this method requires only an HTTP request/response to download the needed information, without the need for downloading and analyzing each page from the site. However, the search is limited to the pages of the submitted URL's only. Consequently, small merchants who do not contract with such specialized engine will not be displayed in the search results.

As is known, webpages of various websites may include information that is not particularly relevant to the particular search in question. For example, many pages may have text banners that are not relevant to the subject of the page itself. Such irrelevant information loads the indexing process and provides no benefit. This is especially true for merchant searching engines, as when a page for a particular product is identified, only information on the page that is relevant to that particular product, such as price, color, size, and other specifications, is needed. All other information can be discarded.

Therefore, there is a need in the art for an improved search engine that can identify on a webpage only information relevant to the query submitted. There is also a need in the art for improved scrapping techniques.

### SUMMARY

Improved search engine and scrapping techniques are provided which enable deciphering relevant and irrelevant information presented on a webpage. Webpages information is scrapped through regional tags embedded in the source page, and data downloading techniques are used that take advantage of request methods listed in the HTTP/1.1 specification (described below) to reduce download bandwidth where possible. An innovative computer algorithm discriminates more accurately relevant data (for a product search, such as product title, price, description, availability (“in stock”, “out of stock” or similar descriptive phraseology), product image, shipping policy link, return policy link) from irrelevant data in a way that is based on the way a web browser displays or renders the layout of the target page.

According to an aspect of the invention, an improved search engine is provided which utilizes page layout markers (e.g., HTML table or division markup tags, sometimes referred to simply as div tags, and the internal DOM structure) to decipher relevant and irrelevant information presented on a webpage. That is, according to various aspects of the invention, information regarding the layout placement of various elements or regions of the webpage is utilized to make a decision on whether the information presented within each division or section of the webpage is relevant or not.

According to an aspect of the invention, a method for searching on the web proceeds as follows. A crawler collects webpages and obtains a list of URL's and source HTML documents in a recursive loop of interest to collect data used to construct a searchable index. The HTML stream is received for each relevant URL and each HTML stream is loaded into a browser so as to render the page, create an internal DOM and run-time data structures. From within the browser operating system process, the run-time data structure for each page is obtained. The data structure is converted into an XML stream as a result of dumping the internal state of the Document Object Model (DOM) and associated rendering run-time data structure information. Then, the XML stream is then parsed to obtain layout information of the webpage. This can also be included as part of the browser process or architected in a client server model, the client being the computer process connecting to convey the URL, and the server represented by the modified web browser process so that no data dumping and external parsing needs to occur while additional efficiencies are achieved, e.g. the overhead associated with starting a new browser operating system process for each URL. The layout information can include location and size of images, text, video clips, banners, and other media forms commonly seen on web pages. Using various heuristics, selected items of interest are identified as relevant according to their associated layout information. After these steps are completed for the URLs of interest, when a query is received and a match is found in the index, only the information identified as relevant is fetched and presented to the user.

According to various aspects of the invention, a method for utilizing computing systems to automatically extract relevant information from a webpage is provided; the method comprising obtaining a data stream of the webpage; analyzing the data stream to determine layout information for each element in the data stream; applying heuristics to the layout information to identify each element as being relevant or irrelevant; and extracting from the data stream data corresponding to each element identified as relevant. According to some aspects, the data stream is one of an HTML or SGML data stream. According to other aspects, the analyzing part comprises rendering the data stream to obtain run-time data structure; and analyzing the run-time data structure to determine layout instructions for each element in the data stream.

According to yet other aspects, the method further comprises constructing a URL table, the URL table comprising URL entries, each entry having a URL and a corresponding element data relating only to the relevant elements. The method may further comprise constructing a search index having at least one corresponding entry for each URL entry in the URL table. The method may further comprise the steps: upon receiving a URL query, interrogating the URL table for all URL's matching the URL query and fetching element data corresponding to all URL's matching said URL query as a form of merchant product page analysis. The analyzing part may comprise constructing a layout database, each entry of the layout database comprising layout instruction for each element and HTML data for the corresponding element. The method may further comprise reporting layout data corresponding to each node in the run-time data structure.

According to yet other aspects of the invention a method for utilizing computing systems to automatically extract relevant information from a webpage is provided, the method comprising: obtaining a URL for the webpage; obtaining an HTML stream corresponding to the URL; rendering the HTML stream to obtain run-time data structure; analyzing the run-time data structure to determine layout instructions for each element in said HTML stream; and applying heuristics to the layout instructions to select only relevant elements of said HTML stream. The method may further comprise constructing a URL table, the URL table comprising URL entries, each entry having a URL and a corresponding XML/HTML data stream relating only to the relevant elements.

The method may also comprise constructing a search index having at least one corresponding entry for each URL entry in the URL table. The method may further comprise receiving a query term, interrogating the search index for an entry matching the query term. When a matching term is obtained, the process will follow by fetching the URL corresponding to the matching term and then interrogating the URL table for a data entry corresponding to the matching URL, and then composing or fetching XML/HTML data stream corresponding to the matching URL from the URL table. The method may further comprise reporting layout data corresponding to each node in the run-time data structure. The rendering may comprise utilizing a web browser engine to generate a Document Object Model (DOM) tree, and modifying the browser so as to cause the browser to report layout data of each node in the DOM tree. The method may further comprise receiving the layout data from the browser and generating a layout database comprising entries of the layout data and HTML text corresponding to the layout data of each node. The part of applying heuristics may comprise applying heuristics to each entry in the layout database.

According to yet other aspects of the invention, a computerized system for enabling reporting of search results from various websites is provided, the system comprising a layout database comprising a plurality of entries, each entry comprising element layout data and corresponding HTML text; a URL database comprising a plurality of entries, each entry comprising a URL and selected data from a webpage linked by the corresponding URL; a search index having a plurality of entries, each entry comprising a query term and corresponding URL's linking to webpages wherein said query term appears; and a processor receiving a user query term and interrogating the search index to fetch URL's matching the user's query term and thereupon fetching selected data corresponding to the URL's matching the user query term from the URL database. The processor may further analyze entries in the layout database to select relevant entries, and use the relevant entries to update the URL database. The system may further comprise a web crawler traversing web links on the Internet and providing relevant URL's to the processor. The processor may further receive the relevant URL's from the crawler and utilize the relevant URL's to construct the layout table.

Other aspects and features of the invention will become apparent from the description of various embodiments described herein, and which come within the scope and spirit of the invention as claimed in the appended claims.

### BRIEF DESCRIPTION OF THE DRAWINGS

The invention is described herein with reference to particular embodiments thereof, which are exemplified in the drawings. It should be understood, however, that the various embodiments depicted in the drawings are only exemplary and may not limit the invention as defined in the appended claims.

FIG. 1a illustrates an example of a webpage for merchandise and templating according to an embodiment of the invention.

FIG. 1b depicts templating according to another embodiment of the invention.

FIG. 2 is a flow chart illustrating an embodiment of the invention.

FIG. 3 is a flow chart of a search process according to an embodiment of the invention.

FIG. 4 depicts a process for extracting relevant information according to an embodiment of the invention.

FIG. 5 depicts the structure of the database constructed according to an embodiment of the invention.

FIG. 6 illustrates a table that is created according to an embodiment of the invention.

FIG. 7 illustrates one results screen that can be produced using an embodiment of the invention.

FIG. 8 is a flow chart for a refresh method according to an embodiment of the invention.

FIG. 9 is a flow chart of another embodiment of the invention.

FIG. 10 is a flow chart illustrating an algorithm for obtaining the price from a webpage.

FIG. 11 is a flow chart illustrating an algorithm for obtaining the product description from a webpage.

FIG. 12 illustrates a process that may be used to select the product description.

FIG. 13 illustrates a process for selecting the description using the lynx tool.

FIG. 14 illustrates a process for capturing the product availability.

FIG. 15 depicts an illustration of a process to capture the shipping policy link.

FIG. 16 illustrates a process for capturing the return policy link.

FIGS. 17a and 17b illustrate a process for selecting the product image.

### DETAILED DESCRIPTION

The inventive method and system provide an improved searching capability by collecting and presenting only relevant information from each website matching the search query. The inventive method and system are particularly useful for specialized searches, such as shopping search, event search, services search, comparison search, etc. For example, when a user wishes to search and compare various auto insurance providers, the user is only interested in information presented on the provider's webpage relating to auto insurance. However, even if a webpage is found relating to auto insurance, the webpage may also include other items irrelevant to auto insurance, such as information on life insurance, home insurance, etc., banners relating to affiliate companies or other services provided, etc. Various embodiments of the inventive method and system enable extracting only the relevant information for presentation to the user.

To enable clear understanding of the various features and aspects of the invention, much of the following description of the exemplary embodiments relate to shopping and comparison search engines. However, it should be immediately apparent that this is done for illustration only, and that the invention is applicable in other applications as well where information is desired to be isolated from web pages.

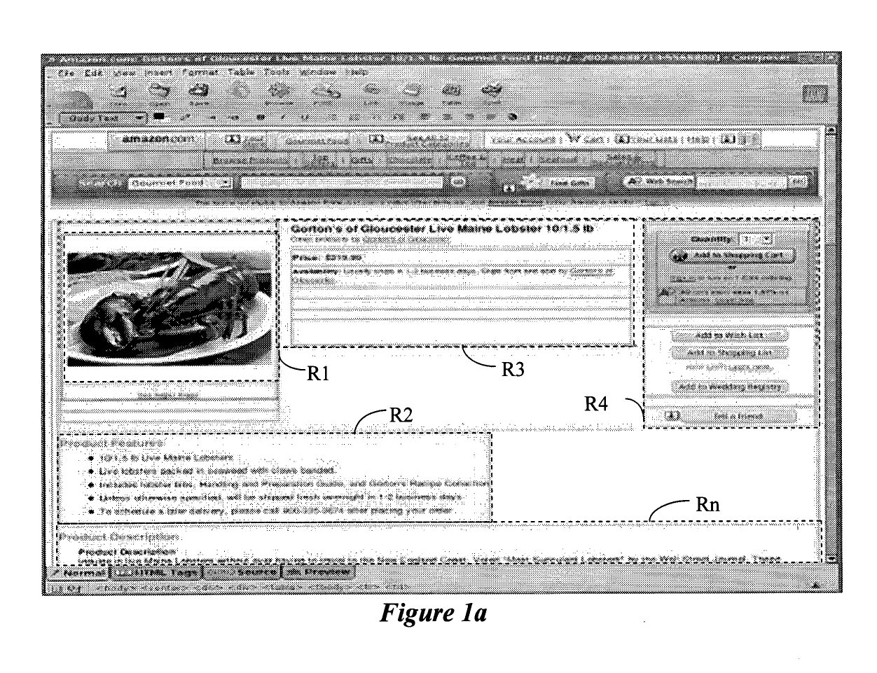

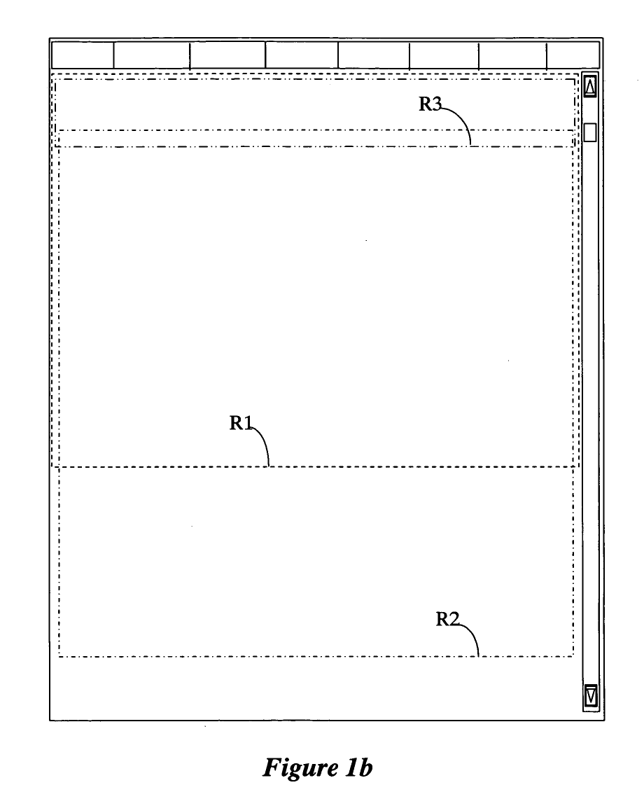

FIG. 1a illustrates an example of a webpage for merchandise. As is commonly done, a picture, 110, of the item is presented, along with other relevant information, e.g., 120, 130, relating to the product. The relevant information may include a description of the product, title, price, availability, (e.g. “in stock”, “out of stock” or similar descriptive phraseology), product image, merchant name and logo, shipping policy link, return policy link) etc. The webpage may also include other information that is not related to the product. For example, purchasing or data saving tools, 140 and 150, are useful only for a person watching this particular page and wanting to take an action with respect to this product. However, for presenting product search results, this information is irrelevant. Therefore, according to various embodiment of the invention such irrelevant information is identified and segregated.

According to various embodiments of the invention, the physical layout of the page is used to identify and segregate irrelevant information. That is, as is known, most webpages follow certain layout formulae in presenting information. For example, for a shopping page the product image would be presented relatively near the top of the page, along with a description of the product in close proximity. Less relevant information, such as customers' reviews, etc., will be presented at the bottom of the page. Moreover, for pages of different products offered from the same merchant, all the pages would follow the same graphical layout. That is, for instance, all product pages from Amazon.com would have the product image near the left, ordering tools on the right, product details in between the image and ordering tools, etc. Thus, for a particular merchant, it is predictable where all information would be graphically placed within the display. This observation is made use of in various embodiments of the subject invention. That is, various embodiments of the invention analyze the regional placement of each element of the page within the webpage layout to decide whether the particular element is relevant to be scrapped or not in a templating fashion, given that the layout is predefined in a blueprint manner due to its published existence from the originating website.

According to one embodiment, illustrated in FIG. 1a, templating is done using knowledge of each merchant's webpage layout. That is, for each merchant, the generic layout for products webpages on the merchant's website is studied, and a template is made to conform specifically to that layout. This is illustrated by the broken-line rectangles R1-Rn in FIG. 1a. However, it is not efficient to study every website and form a template for every website. Accordingly, another templating method is illustrated in FIG. 1b. According to the embodiment depicted in FIG. 1b, the website area is divided into regions, and each region is defined in a generic template. For example, broken-line region R1 in FIG. 1b can designate an image area. That is, the template can be defined so that any picture found within that area is defined as a potential product image. If more than one image is found within the area R1, then weighting can be done to decide which picture is more likely to be the product image. For example, a picture that is closer to the upper-right corner of the screen can be given highest weight, as generally product images are shown in the upper-right corner of webpages. Other regions can be defined, such as line-dot rectangle R2 and line-two dots R3, which may or may not overlap other areas. In this example, the template can be set so that any text found in region R3 is defined as potential title, while any text found in region R2 is defined as potential product description. As can be understood, other templates can be defined to suit other situations, and combinations of templates can be used in the same engine.

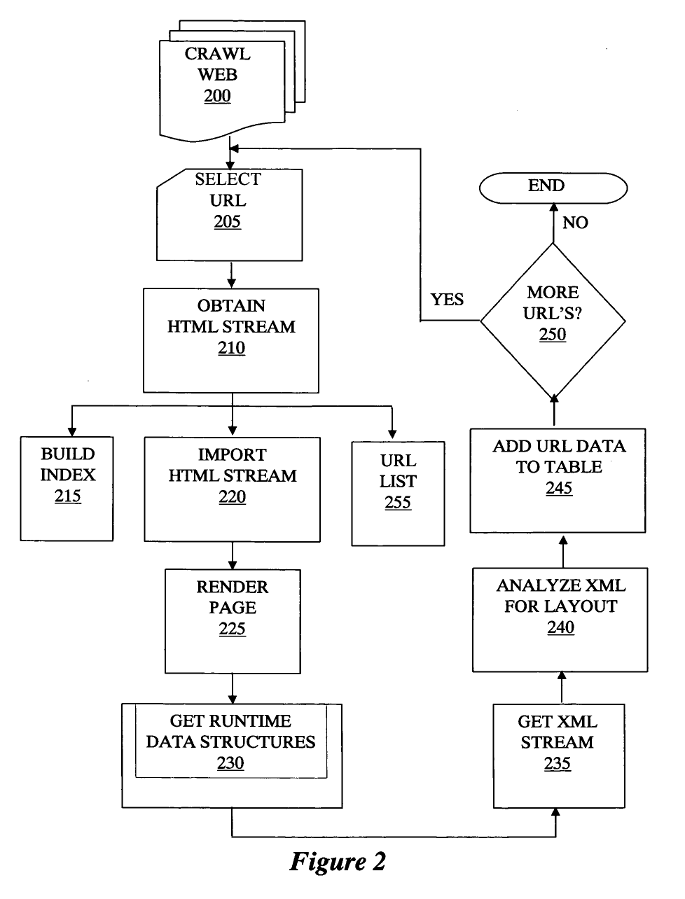

FIG. 2 is a flow chart illustrating an embodiment of the invention. The process of FIG. 2 is performed so as to generate the index and database in order to provide users with search results. The process of FIG. 2 can be performed continuously so as to provides updates to existing data and add new data of items newly found on the web. The process of FIG. 2 is performed independently and separately from serving user's inquiries. In Step 200 of FIG. 2, a crawler is employed to traverse links and collect data on the web, in a rather conventional manner. When a webpage of interest is found, i.e., a URL is selected in step 205, the HTML stream is obtained from that webpage, step 210. The URL and HTML stream are used to build the search index, step 215, in a conventional manner. Additionally, a URL visited list 255 is generated, also using conventional methods. However, unlike conventional processing, according to this embodiment, the HTML stream is loaded into a browser or browser rendering engine operating system process in step 220. The browser then renders the page in step 225, so as to get run-time data structure in step 230. An XML stream is then obtained from the run-time data structure, step 235, and is analyzed in step 240 to determine the page's layout. Using the layout information, areas containing information of interest are extracted from the HTML stream and the data is added to a URL data table in step 245. In step 250 it is determined whether other URL's exist for processing and, if so, the process repeats from step 205. Otherwise the process ends.

The results of the processing illustrated in FIG. 2 are a search index and a URL data table. That is, for each URL of interest, there is an entry in the search index and a corresponding entry in the URL data table. However, due to the inventive processing exemplified in FIG. 2, the data in the URL data table is only the data that is relevant to the particular subject of the page. In this manner, if a search in the search index results in a URL of interest, the corresponding data can be obtained from the URL data table, and that information would contain only relevant information from the corresponding webpage, rather than all of the information from the webpage.

As can be understood, the embodiment of FIG. 2 provides data scrapping by using a browser to render the page, and using the page layout information to determine where relevant information is presented. Using a browser to render the page results in fusing web technologies such as HTML, Javascript, Cascading Style Sheets (CSS), AJAX, XML, XSLT and other browser supported technologies. That is, by using a browser to render the page before the layout is analyzed, various display-enhancing features are captured and used for scoring the data presented. Thus, the inventive method captures layout information that is embedded in these browser supported technologies.

Additionally, in step 220, when the HTML stream IMG-tags (or similarly functioning tags) points to an image to be downloaded and included in the webpage, according to a feature of the invention the image is not downloaded. Instead, a HEAD and/or RANGE request is sent using the URL embedded in the HTML stream for the image. According to the Hypertext Transfer Protocol—HTTP/1.1, a response to such a HEAD or RANGE request includes the header of the image, which includes the size of the image, among other relevant data about the image. At this stage, the system knows the location of the image from the HTML stream and the size and dimensions (e.g. height, width) of the image from the header, so the relevancy and scoring of the image can be determined without having to download the image. This saves on bandwidth, download, and processing time.

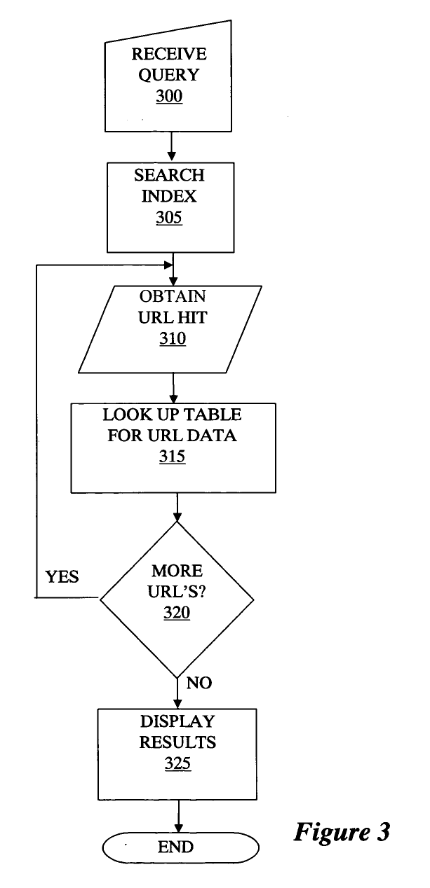

FIG. 3 is a flow chart of a search process according to an embodiment of the invention. In step 300 a query is received from a user. The query may consist of, e.g., a product name. The search index is then searched for hits corresponding to the query, step 305. When a hit is found in step 310, the URL data table is searched for a corresponding URL of the hit in step 315, and the corresponding data is fetched. In step 320 it is checked whether there are other URL hits. If so, the process reverts to step 310. Otherwise, in step 325 all of the data fetched from the URL data table are displayed for the user as a result of the query.

As can be understood, since the data stored in the URL data table includes only information relevant to the subject, when the results are displayed to the user, only relevant information is presented. Additionally, the results can be stored in the URL data table in a pre-selected uniform format, so that when the results are presented to the user, the results of all the hits are presented in a graphically uniform manner, even if the results were obtained from various websites having different formats.

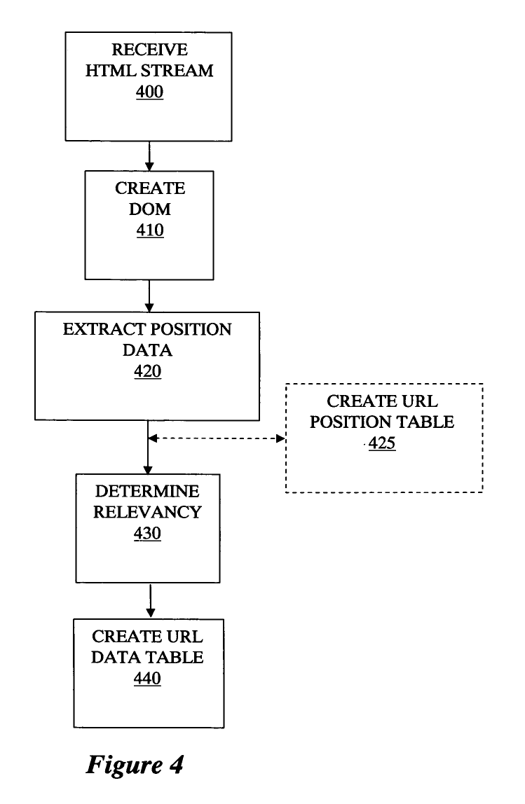

FIG. 4 depicts a process for extracting relevant information according to an embodiment of the invention. The process illustrated in FIG. 4 can be implemented in conjunction with the process depicted in FIG. 2. Once the HTML document is communicated to the browser, step 400, the browser applies its rendering composer engine against the document. Internally, within the browser process, a Document Object Model (DOM) tree is created, in step 410. Document Object Model is a description of how an HTML or XML document is represented in a tree structure. DOM provides a data structure that allows data separation and classification into a well defined tree structure for simplified retrieval. The DOM tree will contain leaf elements, identified in the Seamonkey browser source code package, seamonkey-1.0b.source.tar.gz downloadable via ftp from address ftp://ftp.mozilla.orglpublic/mozilla.org/seamonkey/releases/1.0b/ developed by the Mozilla open source project, as a Cross Platform Component Object Model (XPCOM) nsIDOMElement interface during specific states in the run-time Seamonkey browser or other programmer modified browser process. Associated with these elements are X, Y, coordinate positions measuring the distance in pixels from the inside browser frame to upper left hand corner of the enclosing rectangle region. The region's width, height, left border, top border size, and inner left and top margins are also present. This coordinates information is extractable from the run-time data structures in step 420 and can be provided as input to an external process or optionally incorporated internal to the process to determine relevancy. That is, using the graphical layout expressed by the coordinates and size information, relevancy of each area expressed by a set of coordinates and size is determined in step 430. Then, in step 440, a URL data table is created, which includes for each URL only the data that was determined to be relevant from that webpage.

One optional method for assisting in managing the HTML data analysis is shown by the broken-line step 425. That is, after the DOM is obtained, a table is created that has an entry for each set of coordinates and for each such entry a corresponding entry of the HTML text that corresponds to that coordinates set. That is, each entry includes the coordinates for each location within the webpage, and the HTML text that defines what would be presented in that region of the webpage. For example one set of coordinates can specify the location within the page to place the product image, and the corresponding HTML text would be the data corresponding to the image. Another set of coordinates may indicate the location of text that describes the product, and the corresponding HTML text would be the actual text to be inserted in that area to describe the product. Then, only the entries that correspond to regions of the page that generally convey relevant information are selected, and the corresponding HTML text is used to construct the URL data table.

As noted above, various heuristics can be used to determine which areas of each page layout contain relevant information during the data collection and page scrapping process in FIG. 4, step 430. For example, various large merchants have a set format for displaying information for all of their products. Knowing the layout format for the merchant, one can set the layout selection beforehand for all such merchants. Of course, other scoring heuristics can be used to identify relevant information even when the layout is not known beforehand. For example, to obtain the image of the product, one can set the selection to be: largest and/or squarest image on the page; image appearing on top one-third area of the page; image appearing on left-hand side of the page, etc. Of course, these conditions can be set as an OR function, with a scoring provision for resolving conflicts. For example, image size can be given higher weight than image location, or left-side placement lower weight than top-page placement, etc. Similar rules can be written for text and other items on the webpages.

In step 430, the HTML markup tags embedded in the page can be used in the scoring as well. For example, these include bolded or emphasized words or phrases which tend to indicate important information, such as product titles. As another example, the appearance of many consecutive words tend to denote a product description. On the other hand, visual queues can also be used in combination with the positional scoring algorithms. For example, symbols and words such as a number with decimal point and two digits (“nn.nn”), dollar sign “$”, terms such as “shopping cart”, “shipping”, “free shipping”, “shipping cost”, “ships in ______ days”, “add to cart”, “our price”, “price after rebate”, “in stock”, “list price”, “product description”, “availability” would be devised as part of the regular expression used for matching the text to identify the relevant information.

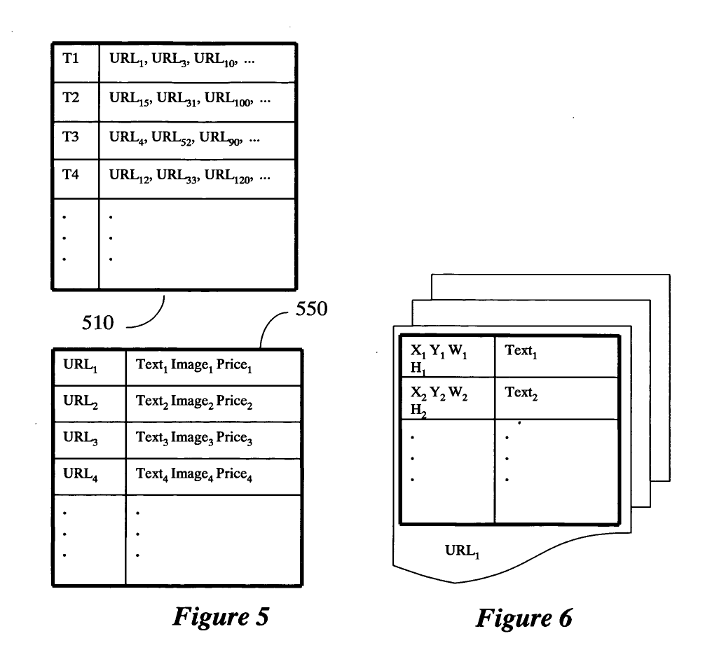

FIG. 5 depicts the structure of the database constructed according to an embodiment of the invention. As is shown, a search index 510 is generated for various search terms T1, T2, . . . Tn. For each term corresponding URL's entries are provided, each URL being a pointer to a webpage where the term is found e.g., URL₁, URL₃, URL₁₀, etc. Notably, search index 510 is generated and updated, for example, in step 215 of FIG. 2, wherein any conventional process for building such an index can be used. Such an index is sometimes referred to as an “inverted index,” and is commonly used by conventional search engines. A conventional inverted index provides mapping from words to locations in documents where the words are used. The index may either provide a mapping to the proper documents, or a mapping to the documents and the location within each document where the term is used. Another data structure, optimized for searching, is generally referred to as a B-Tree, and is commonly used to organize these indices.

According to an embodiment of the invention, when a user enters a term for a search, the index 510 is interrogated to fetch all URL's for webpages where the term appears. Once the URL's are fetched, URL data table 550 is interrogated for all entries matching the URL's. URL data table 550 comprise entries of URL's, wherein for each URL entry, the corresponding relevant data from the page corresponding to the URL is stored. In this example, the relevant data is already stored in a uniform format for presentation for the user. For example, for each entry, fields can be created for text, image, price, etc., as illustrated in FIG. 5. Thus, when a matching URL is found in the URL data table 550, the corresponding relevant data is fetch. Since the entry stored in the URL data table contains only information relevant to the search, and not the entire page, only relevant information is fetched and presented to the user.

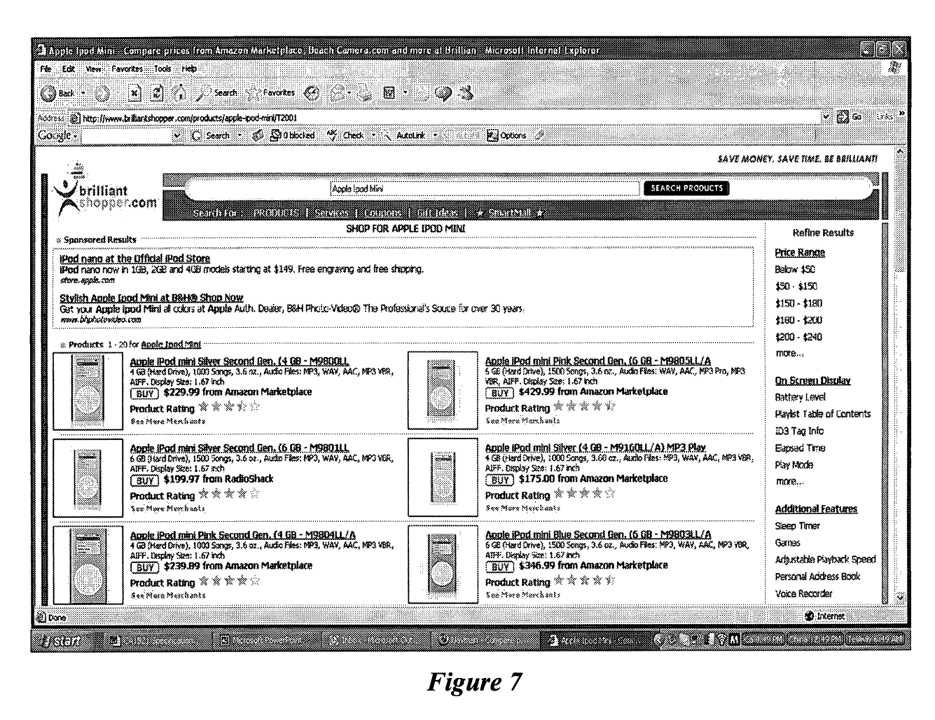

According to an embodiment of the invention, a browser, such as Internet Explorer, Mozilla Firefox, etc., is modified as follows. Generally, once a webpage is loaded into a browser, a DOM is constructed, as explained above. According to this embodiment, the browser's source code is modified or a published Application Programming Interface (API) by the software manufacturer is exploited so that the DOM and/or internal run-time data structures are accessed and the program iterates through all the data nodes to fetch the associated layout coordinates of each region of the webpage. That is, as illustrated in FIG. 1, a webpage can be constructed using regions R1-Rn, wherein each region is defined by a table or div HTML mark-up tag, each defining a region, i.e., its x, y, coordinates, its width and height, left and top border size, left and top margins measured in pixels or similar measuring units, etc. According to this embodiment, the browser source code is modified or API exploited so that it reports all of the coordinates for all of the regions. In this particular example, a table is created, such as the one exemplified in FIG. 6. That is, for each URL (URL₁-URLₙ) entries are provided for all of the regions. Each entry comprises the coordinates of the region, e.g., X₁, Y₁, W₁, H₁, and the corresponding HTML text relating to that region. Once this table is constructed, it is possible to select the HTML text that corresponds to relevant information by simply selecting HTML text entries corresponding only to regions of interest.

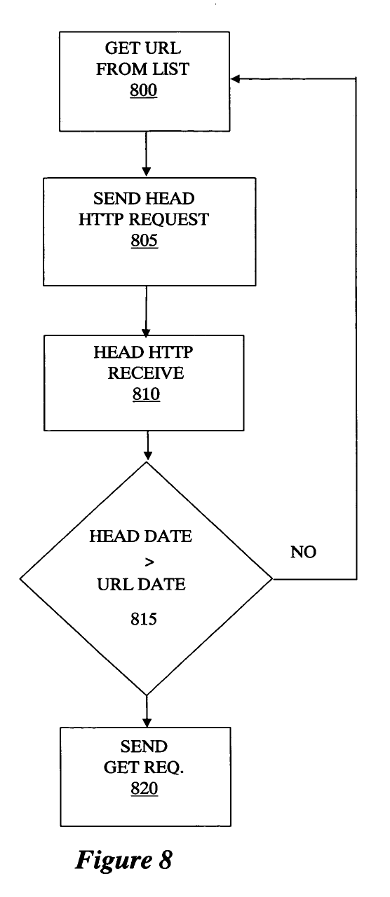

FIG. 7 illustrates one results screen that can be produced using an embodiment of the invention. Notably, all the presented results relate to the same product, but provide information regarding the product from different websites of different merchants. Still from each merchant, only relevant information is fetched and presented, such as product image, product description, price, etc. Also, as shown in FIG. 7, all of the information is presented in the same format for all of the merchants, regardless of the format it was presented in the original webpage.

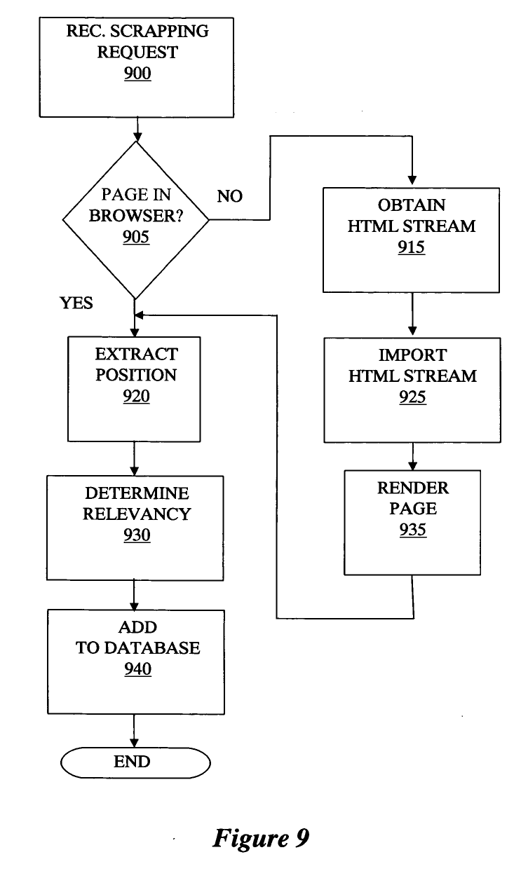

FIG. 8 is a flow chart for a refresh method according to an embodiment of the invention. According to this method, webpages that are included in the index are periodically checked for updates. For this purpose, each URL that is included in the index is listed in the URL list (or database), such as URL list 255, along with the date it was last indexed. The refresh process proceeds as follows. When it is determined that a refresh process should be performed, at step 800 a URL is obtained from the list (e.g., URL list 255). A HEAD request is then sent to that URL address at step 205, to obtain the date this page was last updated. That is, under the definition of Hypertext Transfer Protocol—HTTP/1.1, a response to a HEAD request includes the date the requested page was last modified. Therefore, when the reply to the HEAD request is received at step 810, the date field from the HEAD is compared with the date from the URL list at step 815. If the HEAD date is not after the URL list date, then the process goes back to step 800 to retrieve another URL. However, if the HEAD date is after the URL list date, i.e., the page was modified after the date it was indexed, a GET request is sent to obtain and index the revised page.

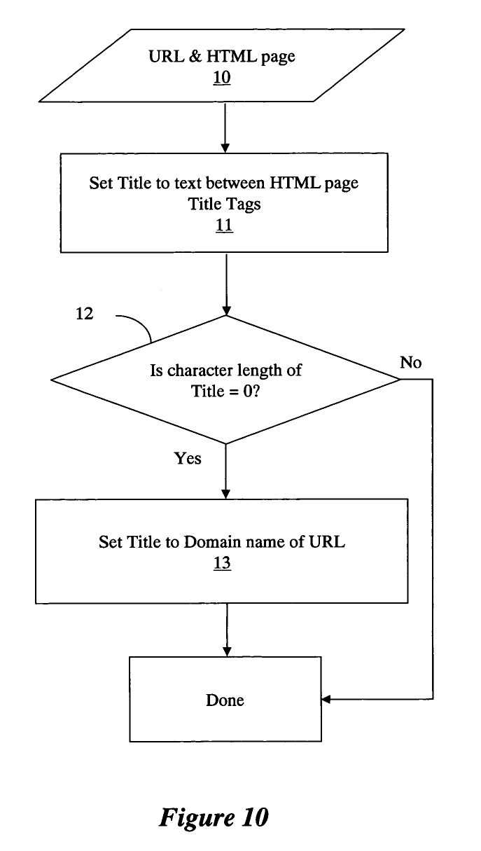

FIG. 9 is a flow chart of another embodiment of the invention. The embodiment of FIG. 9 can be used to build a “local” or “personal” database. To implement the embodiment of FIG. 9, a button can be added to a browser's toolbar to enable the user to scrap a webpage locally. The button can be implemented in a similar manner such as, e.g., a Google toolbar or Kaboodle™ button on a tool bar. When a user finds a website of interest and wishes to scrape information from that site onto a personal database, the user may click the button on the toolbar, to thereby begin the process depicted in FIG. 9. That is, the process of FIG. 9 begins when a scrapping request is received at step 900 by a user clicking on the scrapping button. Here, as can be understood, if the user is looking at the website (step 905), the page has already been rendered by the browser. Therefore, the process proceeds to step 920 where positions of each element is determined from the layout information, e.g., from the DOM nodes. Then, layout information is used to determine the relevancy of each element in step 930, so as to extract only relevant information, as described previously. Then in step 940 the relevant elements are added to the local database, which can be stored in the user's personal computer or on a remote server of a service provider. On the other hand, if at step 905 it is determined that the webpage is not in the browser or rendering engine, e.g., the user enters a URL in the toolbar, but is not looking at that page at that particular moment, the process proceeds to step 915, where the HTML stream is obtained, e.g., by sending GET requests for the page's URL and HEAD and/or RANGE if the data is not already cached HTTP requests for any images within that page. The HTML stream is imported into the browser at step 925 and the browser renders the page in step 935. From there the process proceeds to step 920, already described above.

Another embodiment of the invention relates to capturing the relevant shopping page information using rule-based algorithms which are described in the follow paragraphs.

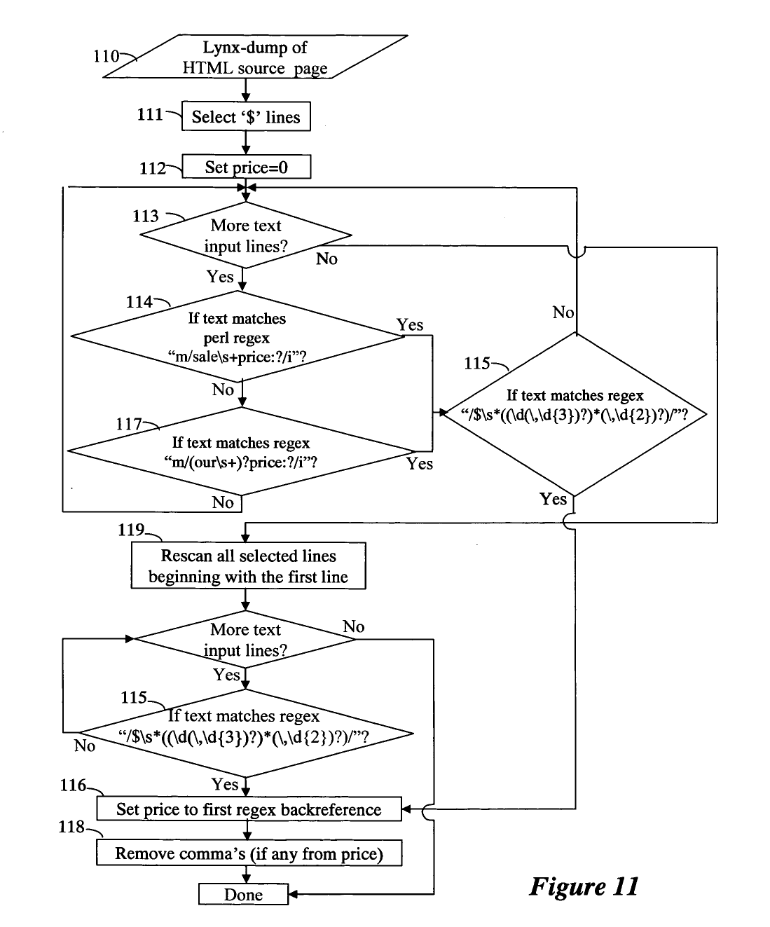

Product Title: an embodiment for the process to capture the product title is illustrated in FIG. 10. In step 10 the process proceeds to get the HTML source page. In step 11, the process selects the text between the HTML Title markup tags sets it as the product title. In step 12 the process checks whether the character length is zero, i.e., there is no text set in the title tag. If so, in step 13 the title is set to the domain name of the URL.

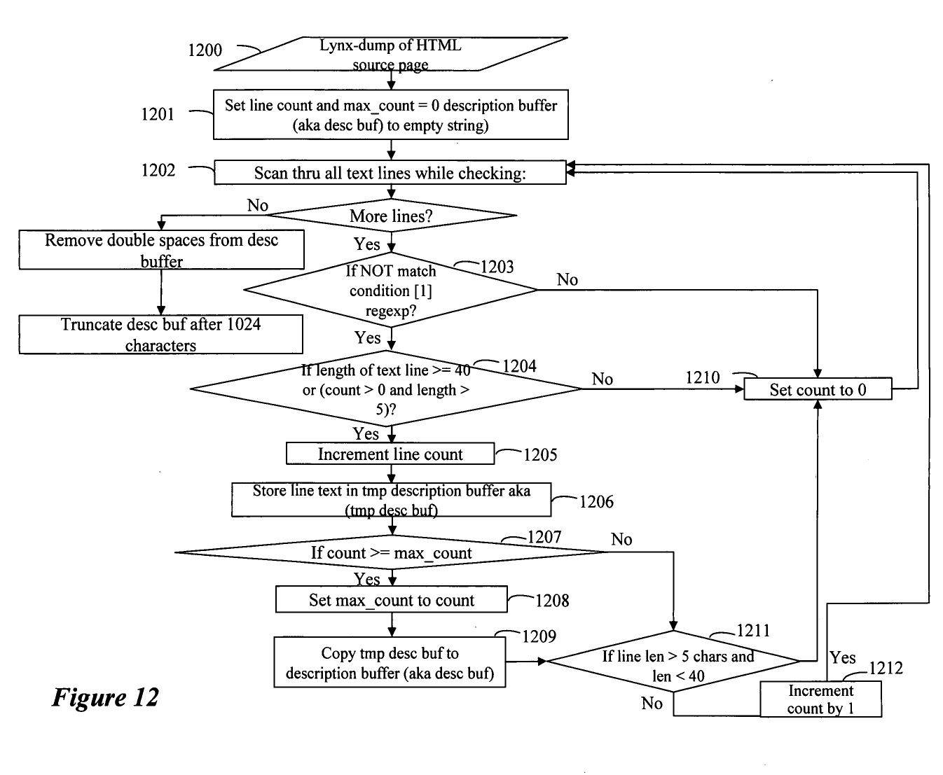

Product Price: to select the price, the following algorithm is used, as illustrated in FIG. 11. In step 110, get the text from HTML source web page using the “lynx-dump” command form of the Lynx Version 2.8.4rel.1 (17 Jul. 2001) tool running on operating system Debian GNU/Linux Sarge release (v.3.1). In step 111, select all lines containing the dollar symbol (e.g. ‘$’). In step 112, set a variable price to value 0. In step 113, scan one line from the text selected above. In step 114, if the line contains text regular expression “m/sale\s*price:?/i” in Perl, v5.8.4 built for i386-linux-thread-multi, or in other words having key phrase “sale price” or “sale price:” with any number of white space between the words, then proceed to step 115 to check if there is a number matching the regular expression defined by “m/\s*\$\s*((\d(\,\d{3})?)*(\.\d{2})?)/i”, e.g. a decimal digit or any number of decimal digits followed by a decimal point, even if there are commas, and two more consecutive decimal numbers to the right of the decimal place, then set that to the price in step 116. If step 114 returns negative, go to step 117 and check whether the line contains text “our price”, “price”, “our price:”, or “price:” with any number of whitespace between the words. If so, go to step 115 and check if there is a number with the same number form as mentioned earlier, then set that to the price in step 116. If price contains commas, remove them in step 118. If price is still 0, then re-scan the selected line at step 118, while in step 115′ searching for the first line that contains a number of a similar form as aforementioned step 115 and setting that to the price in step 116.

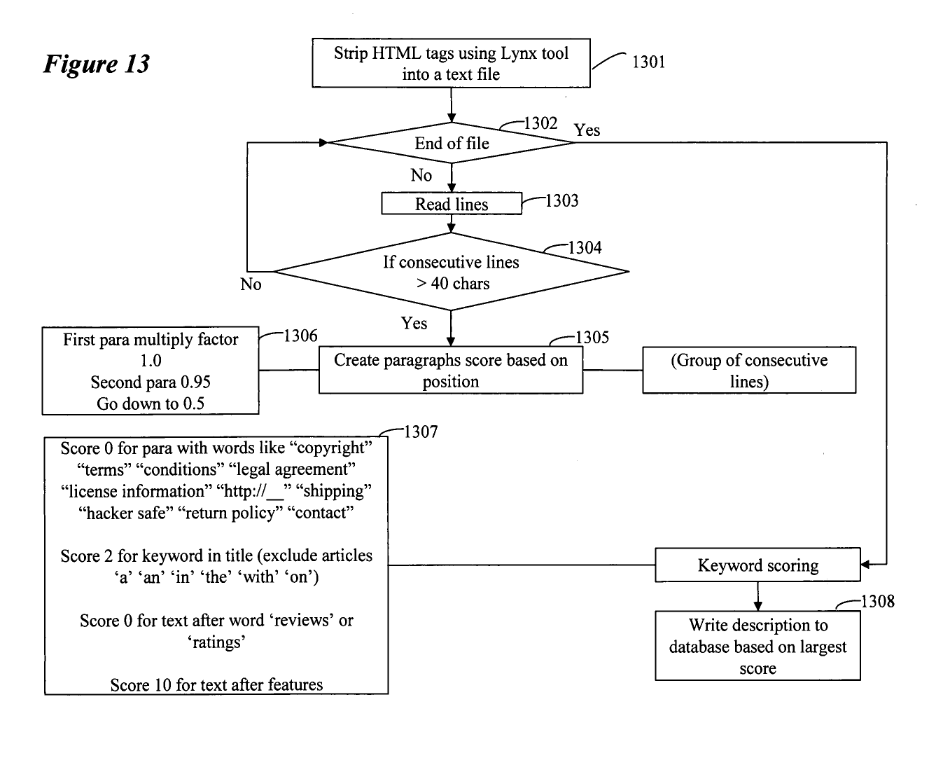

Product Description: the process illustrated in FIG. 12 may be used to select the product description. In step 1200, a Lynx dump of the HTML source page is obtained. In step 1201 set line count to 0 and set max count to 0. In step 1202 loop each line of the lynx text output and for each line check for the following conditions. If text does not contain phrases “copyright”, “terms & conditions”, “legal agreement”, “license information”, “http:/”, “______”, “hacker safe”, “return policy”, or “contact”, in step 1203 go to step 1204 to check if text length for the line is equal to or greater than 40 characters or line counter is greater than 0 and line length is greater than 5. If so, increase line description counter by 1 in step 1205 and save the line to the description buffer in step 1206. If count is greater or equals max count in step 1207, then the max count is set to the current count in step 1208 and the description is copied from the temporary buffer to the description buffer in step 1209. If step 1204 returns a negative, the count is set to zero at step 1210 and another line is scanned. If at step 1211 line length is greater than 5 and less than 40 characters, then increment the count by 1 at step 1212 and scan another line. Otherwise, set the count to 0 at step 1210. After looping all the lines truncate description buffer text length by 1024.

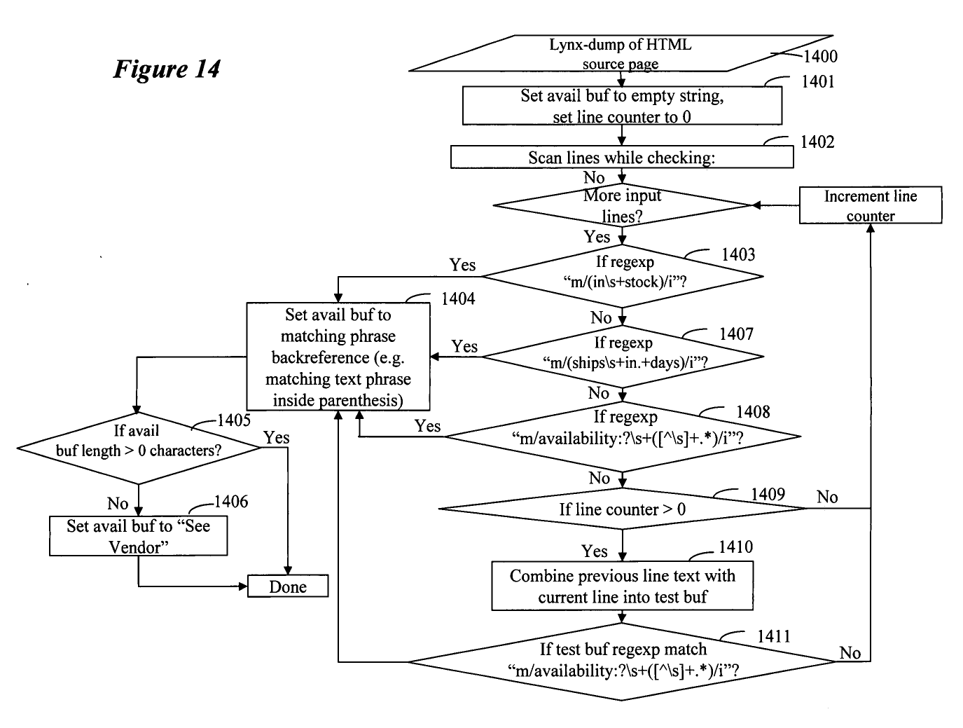

Another algorithm to selecting the description captures the text of the web page using the lynx tool as described above, then loops through each line performing the following tests and operations (FIG. 13). In step 1301, strip HTML tags. In step 1302, if not looped through all of the lines, then go to step 1303 and read a line. In step 1304 if the total of consecutive lines is greater than or equal to 40 characters in length, then create paragraphs score in step 1305, based on position such that: if first paragraph, then multiply score by 1 or if second paragraph, multiply by 0.95 and so on down to 0.5 for the last paragraph (1306). In step 1304, if the total of consecutive lines is not equal to or less than 40 characters, then go to step 1302 to check for end of file above. If all lines have been looped through, perform the following keyword scoring in step 1307: Multiply score by 0 for paragraph with words like “copyright”, “terms”, “conditions”, “legal agreement”, “license information”, “http://”, and “shipping”. Multiply score by 2 for keyword in title excluding articles “a”, “an”, “in”, “the”, “with”, “on”. Multiply score by 0 for text after word “reviews” or “ratings”. Multiply score by 10 for text appearing after “features”. In all cases capitalization and white space between word phrases are ignored. In step 1308, the description is selected based on the highest score.

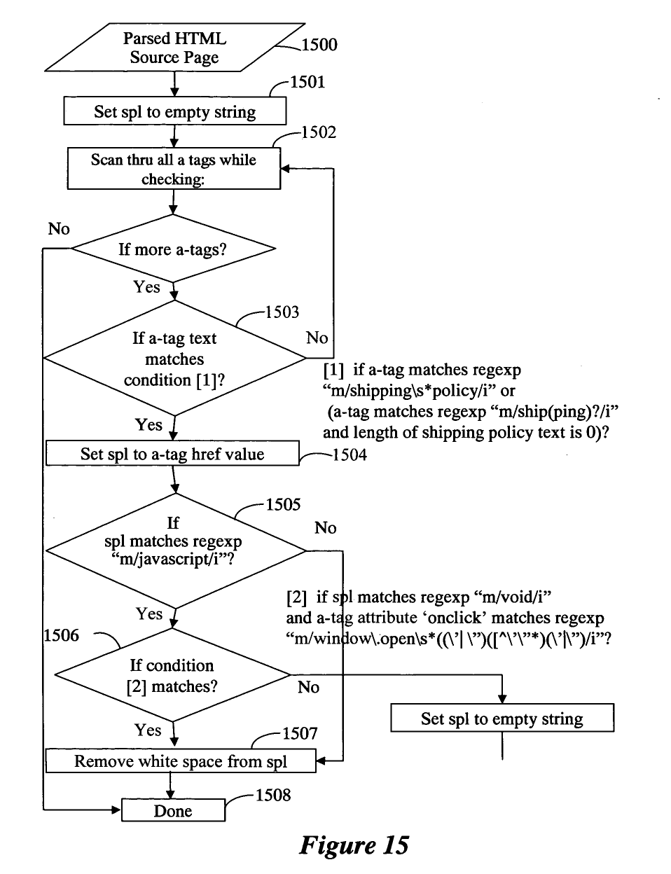

Product Availability: to capture the product availability, the following algorithm illustrated in FIG. 14 may be used. In step 1400 a lynx dump of the HTML source page is obtained. In step 1401 a variable, available buffer, is set to an empty string and line counter is set to zero. In step 1402 scan each line of the text of the lynx dump output and perform the following checks. If in step 1403 the text matches the regular expression “m/(in\s*stock)/i”, set this as the value in step 1404. In step 1405 it is checked whether the available buffer is greater than zero. If so, the available buffer is set to “see vendor” in step 1406 and the loop id exited. If step 1403 returns a negative, in step 1407 it is checked whether the text is matches “m/(ships\s*in.*days)/i” and, if so, the process proceeds to step 1404. Otherwise, the step proceeds to step 1408 to see whether the text matches the regular expression, “m/availability:?\$+([̂\$]+.*)/i” and, if so, proceed to step 1404. If step 1408 returns a negative, the process proceeds to step 1409 to check whether the line counter is larger than zero. If so, the process proceeds to step 1410 to concatenate the first line with second and check if text matches regular expression “m/availability:?\s+([̂\s]+.*)/i” in step 1411. If it does, the process proceeds to step 1404.

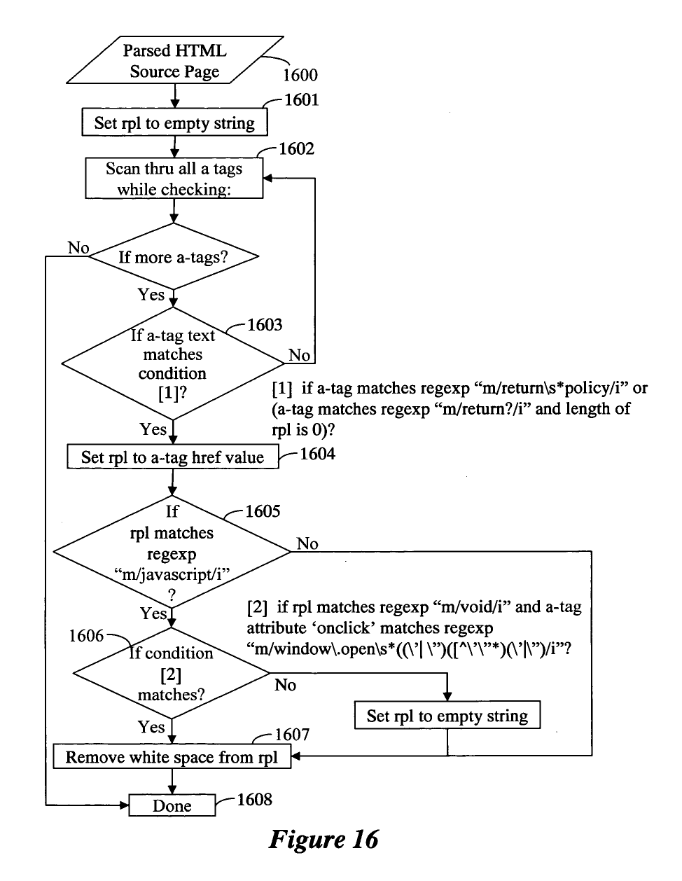

Shipping Policy: FIG. 15 depicts an illustration of a process to capture the shipping policy link. In step 1500 the process parses the HTML source page. In step 1501 the process sets a “shipping policy” variable to empty string. In step 1502, the process looks at HTML hyper links (a-tags) one by one starting with the first one and performs the following tests. If in step 1503 the text matches regular expression, “m/shipping\s*policy/i” or “m/shipp(ing)?\s*/i” and current text length of shipping policy link is 0, then in step 1504 the process sets the shipping policy variable to the link destination. In step 1505 the process checks whether the shipping policy matches the regular expression “m/javascript/i” and, if so, it proceeds to step 1506 to check whether the shipping policy variable matches the regular expression “m/void/i” and the a-tag attribute ‘on click’ matches the regular expression “m/window\.open\s*((‘|\”)([̂\‘\”*](\‘|\”)/i”. If so, the process proceeds to step 1507 to remove white spaces from the shipping policy variable and exits the loop at step 1508.

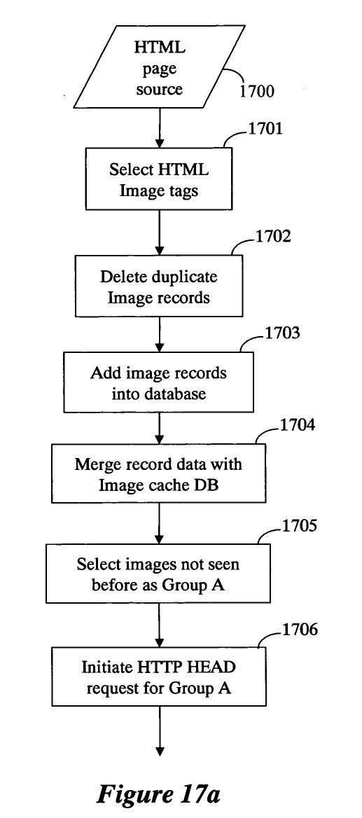

Return Policy: FIG. 16 illustrates a process for capturing the return policy link. The process is similar to that of FIG. 15, so the steps are not repeated and are enumerated correspondingly to the steps of FIG. 15. However, in step 1603 the process checks whether the text matches regular expression “m/return\s*policy/i” or “m/return/i” and if so, uses the link destination as the return policy link value and exit the loop at 1608.

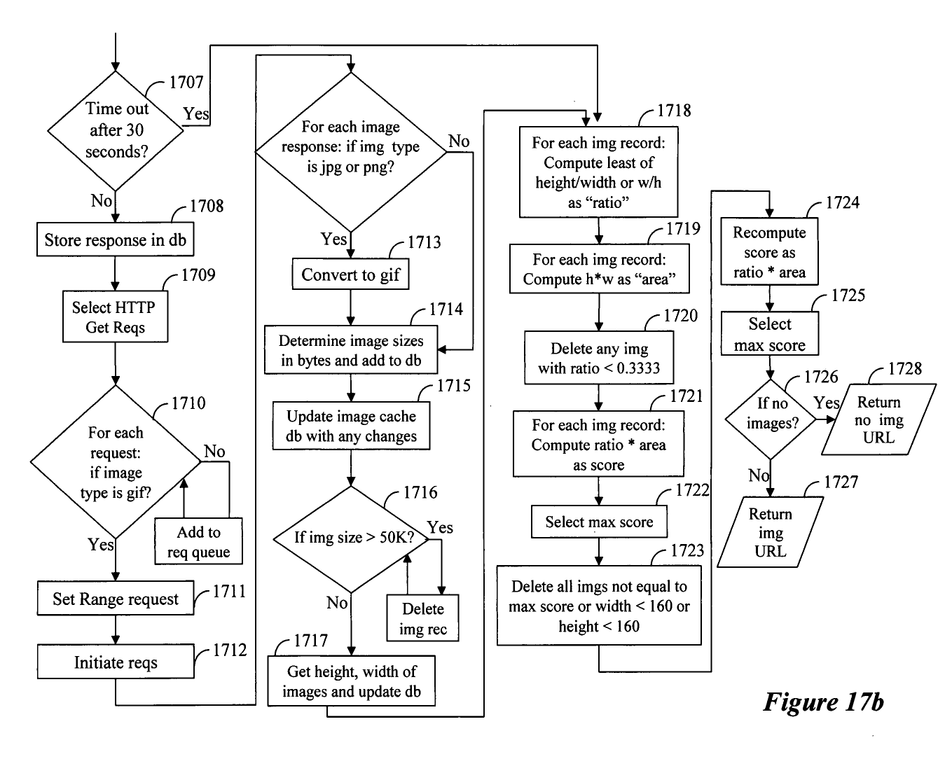

Product image: FIGS. 17a and 17b illustrate a process for selecting the product image. In step 1700 the process obtains the HTML page source and in step 1701 selects the HTML Image tags. In step 1702 the process deletes images appearing more than once and in step 1703 the process creates image records in a database. In step 1704 the process merges matching image records with image cache to verify if any image was processed before. In step 1705 the process selects images not seen before and designates those as Group A, and then creates HTTP HEAD request for Group A and adds every image to a parallel request message queue (step 1706). The process sends the image head requests, wait for response or time out after 30 seconds (step 1707). In step 1708 the process stores the response received from the remote server and selects last modified date, etag, content length, date of file, content type (e.g. gif/jpg/png) and updates the image record with this data. In step 1709 the process selects HTTP GET request candidates. In step 1710 the process checks whether the image is in gif format and if so, at step 1711 it sets a Range request and initiates the request in step 1712. For images that are in the jpg or png format, the process converts them to gif format in step 1713. In step 1714 the process checks the image size and in step 1715 it updates the database with any changes necessary. In step 1716 the process checks whether the image size bytes is greater than 50K and, if so, it deletes the image. If the image size is less than 50,000, at 1717 the process obtains the image dimensions: e.g., height and width measured in pixels. In step 1718 the process computes a ratio of height/width and in step 1719 computes the image area (height×width). In step 1720 the process deletes any image having ratio smaller than 0.333, and in step 1721 the process computes a score=ratio×area, and selects the highest score at 1722. At step 1723 the process deletes any image having lower than the max score or having width less than 160 or height less than 160. In step 1724 the score is recomputed as ratio×area and in 1725 the max score is selected. If in step 1726 no image remains, the process returns a “ni image” message. Otherwise, the remaining image is selected.

While the invention has been described with reference to particular embodiments thereof, it is not limited to those embodiments. Specifically, variations and modifications may be implemented by those of ordinary skill in the art without departing from the invention's spirit and scope, as defined by the appended claims. For example, all references to HTML or SGML may include other markup languages. In particular, utilizing the page-as-rendered scraping technique with region information describe previously, has the result of fusing Javascript, and CSS elements and other browsing enhancing technologies, that is captured and used for scoring the data presented.

Because the page-scraping techniques described herein requires downloading images, the web servers supporting the HTTP/1.1 specification allow HEAD/RANGE requests to be made so image meta-information is returned. Part of the HEAD response data returned includes a “Last-Modified” date field allowing the index and product data to be checked for refresh without requiring a full request to be made of the original data. “Content-Length” allows discrimination if size is a scoring factor for selecting an image. The request method RANGE provides partial image transfers to be initiated instead of full image transfers thereby reducing bandwidth, but still allowing the same image scoring algorithms to be exploited. The page scraping and image scoring techniques can be executed on the same machine that crawls websites, but may additionally be employed on a users desktop and activated by a graphical user interface (GUI) toolbar button.

1. A method for utilizing computing systems to automatically extract relevant information from a webpage, comprising:
obtaining a data stream of the webpage;
analyzing said data stream to determine layout information for each element in said data stream;
applying heuristics to the layout information to identify each element as being relevant or irrelevant;
extracting from said data stream data corresponding to each element identified as relevant.

2. The method of claim 1, wherein said data stream is one of an HTML or SGML.

3. The method of claim 1, wherein said analyzing comprises:
rendering said data stream to obtain run-time data structure;
analyzing said run-time data structure to determine layout instructions for each element in said data stream.

4. The method of claim 1, further comprising: constructing a URL table, said URL table comprising URL entries, each entry having a URL and a corresponding element data relating only to said relevant elements.

5. The method of claim 4, further comprising constructing a search index having at least one corresponding entry for each URL entry in said URL table.

6. The method of claim 4, further comprising, upon receiving a URL query, interrogating said URL table for all URL's matching said URL query and fetching element data corresponding to all URL's matching said URL query.

7. The method of claim 3, wherein said analyzing comprises constructing a layout database, each entry of said layout database comprising layout instruction for each element and HTML data for the corresponding element.

8. The method of claim 3, further comprising reporting layout data corresponding to each node in said run-time data structure.

9. The method of claim 2, wherein whenever said HTML stream points to a component URL, the method further comprises sending at least one of a HEAD and/or RANGE HTTP request for said component URL.

10. The method of claim 9, further comprising using component size information from a reply to at least one of said HEAD and/or RANGE HTTP request and layout coordinate information of the component to determine relevancy of said component.

11. The method of claim 1, further comprising constructing a search index and for each indexed URL of a corresponding website in said search index, periodically performing the process comprising:
sending a HEAD request for said indexed URL;
fetching a revised date from a reply to said HEAD request;
comparing said revised date to an indexed date of said indexed URL; and,
if the indexed date preceded the revised date, sending a GET request to re-index the corresponding website.

12. The method of claim 3, wherein said rendering comprises fusing Javascript, Cascading Style Sheets (CSS) elements, AJAX, XML, and XSLT.

13. A method for utilizing computing systems to automatically extract relevant information from a webpage, comprising:
obtaining a URL for the webpage;
obtaining an HTML stream corresponding to the URL;
rendering said HTML stream to obtain run-time data structure;
analyzing said run-time data structure to determine layout instructions for each element in said HTML stream;
applying heuristics to said layout instructions to select only relevant elements of said HTML stream.

14. The method of claim 13, further comprising constructing a URL table, said URL table comprising URL entries, each entry having a URL and a corresponding HTML text relating only to said relevant elements.

15. The method of claim 14, further comprising constructing a search index having at least one corresponding entry for each URL entry in said URL table.

16. The method of claim 15, further comprising: receiving a query term, interrogating said search index for a matching entry matching said query term, when a matching term is obtained, fetching matching URL corresponding to said matching term and then interrogating the URL table for an entry corresponding to the matching URL, and then fetching HTML text corresponding to the matching URL from said URL table.

17. The method of claim 13, further comprising reporting layout data corresponding to each node extracted from said run-time data structure.

18. The method of claim 13, wherein said rendering comprises utilizing a web browser to generate a Document Object Model (DOM) tree, and further comprising modifying said browser so as to cause said browser to report layout data of each node in said DOM tree.

19. The method of claim 18, further comprising receiving said layout data from said browser and generating a layout database comprising entries of said layout data and HTML text corresponding to said layout data of each node.

20. The method of claim 19, wherein said applying heuristics comprises applying heuristics to each entry in said layout database.

21. The method of claim 13, wherein said rendering comprises fusing Javascript, and Cascading Style Sheets (CSS), AJAX, XML, and XSLT.

22. The method of claim 13, wherein said rendering comprises utilizing a web browser to generate a Document Object Model (DOM) tree, and wherein said analyzing comprises obtaining layout data of each node in said DOM tree.

23. The method of claim 13, wherein whenever said HTML stream points to a component URL, the method further comprises sending a HEAD or a RANGE HTTP request for said component URL.

24. The method of claim 13, further comprising providing a clickable button for a user, and wherein said obtaining a URL is initiated by the user clicking on said clickable button.

25. A computerized system for enabling reporting of search results from various websites, comprising:
a URL database comprising a plurality of entries, each entry comprising a URL and selected data from a webpage linked by the corresponding URL;
a search index having a plurality of entries, each entry comprising a query term and corresponding URL's linking to webpages wherein said query term appears;
a browser receiving webpage data and rendering said webpage to obtain layout information of webpage elements;
a processor configured to obtain the layout information from said browser and use said layout information to define at least some of said website elements as said selected data;
a search engine receiving a user query term and interrogating said search index to fetch URL's matching said user query term and thereupon fetching selected data corresponding to said URL's matching said user query term from said URL database.

26. The system of claim 25, wherein said processor further updates said URL database.

27. The system of claim 26, further comprising a web crawler traversing links on the Internet and providing relevant URL's to said browser.

28. The system of claim 27, wherein said processor further receives said relevant URL's from said crawler and utilizes said relevant URL's to construct said search index.
